(19) United States
(12) Patent Application Publication
(10) Pub. No.: US 2015/0162586 A1
(43) Pub. Date: Jun. 11, 2015

(54) NEW SEPARATOR

(71) Applicants: Sion Power Corporation, Tucson, AZ (US); BASF SE, Ludwigshafen (DE)

(72) Inventors: Sven Fleischmann, Ludwigshafen (DE); Ruediger Schmidt, Paderborn (DE); Yuriy V. Mikhaylik, Tucson, AZ (US)

(73) Assignee: Sion Power Corporation, Tucson, AZ (US)

(21) Appl. No.: 14/561,305

(22) Filed: Dec. 5, 2014

Related U.S. Application Data
(60) Provisional application No. 61/912,032, filed on Dec. 5, 2013.

(51) Int. Cl. H01M 2/16; H01M 10/052; H01M 2/14

(52) U.S. Cl. CPC H01M 2/1686; H01M 2/145; H01M 2/1653; H01M 10/052

(57) ABSTRACT

Articles and methods including separators that can be used in electrochemical cells are provided. In some embodiments, a separator comprises at least one separator backbone (as component a)) and at least one polymer (as component b)). The polymer according to component b) may comprises polymerized units of at least one ethylenically unsaturated monomer having no additional functional groups and at least one ethylenically unsaturated anionic monomer. Processes for preparing the separators and the use of said separators in, for example, an electrochemical cell and, in particular, in a battery, are also provided. Electrochemical cells (e.g., a battery) containing a separator are also provided. In some embodiments, lithium-sulfur batteries that include a separator comprising charged groups (e.g., carboxylate groups) are provided.

### RELATED APPLICATIONS

This application claims priority under 35 U.S.C. §119(e) to U.S. Provisional Application Ser. No. 61/912,032, entitled “New Separator,” filed Dec. 5, 2013, which is incorporated herein by reference in its entirety for all purposes.

### FIELD

Articles and methods including separators that can be used in electrochemical cells are provided.

### SUMMARY

Articles and methods including separators that can be used in electrochemical cells are provided. The subject matter of the present invention involves, in some cases, interrelated products, alternative solutions to a particular problem, and/or a plurality of different uses of one or more systems and/or articles.

In one set of embodiments, a separator is provided. In one embodiment, a separator comprises components a) and b) with a) a separator backbone and b) at least one polymer comprising polymerized units of b1), b2) and optionally b3):
b1) at least one ethylenically unsaturated monomer having no additional functional groups,
b2) at least one ethylenically unsaturated anionic monomer, and
b3) optionally at least one further ethylenically unsaturated monomer having at least one additional functional group.

In another set of embodiments, a lithium-sulfur battery is provided. In one embodiment, a lithium-sulfur battery comprises an anode, a cathode, and a separator material arranged in between the anode and the cathode, wherein the separator material comprises carboxylate groups. The separator material may include components a) and/or b) as described herein.

In some of the embodiments described above and herein, the separator or separator material includes a separator backbone (e.g., separator backbone material) which is a polyolefin. The separator backbone may be a layered polyolefin and/or a porous polyolefin, and/or the polyolefin may be polyethylene (PE), polypropylene (PP) or mixtures thereof. In certain embodiments, the separator is a layered, porous PE or PP.

In some of the embodiments described above and herein, the monomer b1) is selected from ethylene, propylene, 1-butene, 2-butene, iso-butene, 1-pentene, 2-pentene, 1-hexene, 1-octene, polyisobutenes having a number-average molecular weight Mₙ of 100 to 1000 Daltons, cyclopentene, cyclohexene, butadiene, isoprene, and styrene. In certain embodiments, the monomer b1) is selected from ethylene, propylene, 1-butene, iso-butene, 1-pentene, 1-hexene, and 1-octene. In some cases, the monomer b1) is ethylene or propylene. In some particular embodiments, the monomer b1) is ethylene.

In some of the embodiments described above and herein, the monomer b2) is selected from acrylic acid, methacrylic acid, itaconic acid, maleic acid or a salt thereof. In some cases, the monomer b2) is acrylic acid or methacrylic acid.

In some of the embodiments described above and herein, the additional functional group of the monomer b3) is selected from hydroxyl, unsubstituted, monosubstituted or disubstituted amino, mercapto, ether, sulfonic acid, phosphoric acid, phosphonic acid, carboxamide, carboxylic ester, sulfonic ester, phosphoric ester, phosphonic ester, or nitrile groups. In some embodiment, the additional functional group is selected from hydroxyl, amino, ether or carboxylic ester groups. In certain embodiments, the additional functional group is selected from ether groups or carboxylic ester groups.

In some of the embodiments described above and herein, the monomer b3) is selected from C₁-C₂₀ alkyl(meth)acrylates, vinyl esters of carboxylic acids comprising up to 20 C atoms, ethylenically unsaturated nitriles, or vinyl ethers of alcohols comprising 1 to 10 C atoms.

In some of the embodiments described above and herein, the polymer according to component b) comprises polymerized units of b1) and b2) with: b1) 70 to 85% by weight of ethylene; and b2) 15 to 30% by weight of acrylic acid and/or methacrylic acid, with the proviso that the sum total always makes 100% by weight.

In some of the embodiments described above and herein, the polymer according to component b) the acidic functional groups originating from the monomer b2) are at least partially neutralized. In some cases, they are completely neutralized. Neutralization may be carried out by reacting the polymer with a base and the base is may be selected from alkali metal oxides, alkali earth metal oxides, hydroxides, hydrogencarbonates, carbonates, or amines. In some cases, the base is LiOH.

In some of the embodiments described above and herein, component b) is attached as a layer to at least one side of the separator backbone of component a) and/or the component b) is contained within the pores of component a). In certain embodiments, the separator backbone is a layered separator backbone comprising at least one layer and the component b) is attached to only one side of this layered separator backbone, which side is preferably the side with the largest area of said layered separator backbone.

In one set of embodiments, a series of processes are provided. In one embodiment, a process for preparing a separator is provided. The process may involve forming a separator comprising components a) and b) described above and/or herein, wherein at least one polymer according to component b) is attached to a separator backbone according to component a). The separator may be obtained by dissolution of at least one polymer according to component b) in a solvent. The solvent may be selected from xylene, toluene or chloroform. This step may be i) followed by doctor-blading the obtained solution of the polymer on the surface of one side of a separator backbone according to component a) and evaporation of the solvent, or ii) followed by soaking the obtained solution of the polymer through the separator backbone.

In certain embodiments with respect to a process described above and/or herein, the polymer according to component a) is at least partially neutralized with at least one base prior to be attached to the separator backbone. In some embodiments, the base is employed as a solution, dispersion or mixture in/with water. In some cases, the base is LiOH in water.

In certain embodiments, use of a separator described above and/or herein in an electrochemical cell or in a battery is provided.

In certain embodiments, an electrochemical cell comprising a separator described above and/or herein is provided. In some embodiments, the electrochemical cell, which is a battery, e.g., a Li/S battery, is provided.

In certain embodiments, a battery described above and/or herein includes a separator material comprising at least one polymer comprising polymerized units of b1), b2) and optionally b3):
b1) at least one ethylenically unsaturated monomer having no additional functional groups,
b2) at least one ethylenically unsaturated anionic monomer, and
b3) optionally at least one further ethylenically unsaturated monomer having at least one additional functional group, provided that the polymer comprises at least one carboxylate group.

In certain embodiments, a separator material described above and/or herein comprises a separator backbone and the at least one polymer is formed on the separator backbone.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows a separator according to one set of embodiments;

FIG. 2 shows another separator according to one set of embodiments; and

FIG. 3 shows an electrochemical cell including a separator according to one set of embodiments.

### DESCRIPTION

Articles and methods including separators that can be used in electrochemical cells are provided. In some embodiments, a separator comprises at least one separator backbone (as component a)) and at least one polymer (as component b)). The polymer according to component b) may comprise polymerized units of at least one ethylenically unsaturated monomer having no additional functional groups and at least one ethylenically unsaturated anionic monomer. Processes for preparing the separators described herein and to the use of said separators in, for example, an electrochemical cell and, in particular, in a battery, are also provided. Furthermore, electrochemical cells (e.g., batteries) including a separator described herein are also provided.

The use of separators in electrochemical cells, especially in batteries, is well known. P. Arora et al. (Chem. Rev. 2004, 104, pages 4419-4462) provides an overview on separators to be employed in different types of batteries/battery configurations, such as button cell batteries, stack lead-acid batteries, spiral wound cylindrical lithium-ion batteries or spiral wound prismatic lithium-ion batteries. Separators for batteries can be divided into different types, depending on their physical and chemical characteristics. They can be molded, woven, nonwoven, microporous, bonded, papers or laminates. In addition, it is also possible to combine an electrolyte and separator into a single component due to the development of solid and shelled electrolytes. In most batteries, the separators are either made of non-woven fabrics or microporous polymeric films. Several commercially available separators are disclosed, mostly based on polyolefins (polyethylene and/or polypropylene), the respective separators may be either single-layered or multi-layered.

US-A 2006/0177732 relates to battery cells having separator structures which include a substantially impervious active metal ion conducting barrier material, such as an ion conducting glass, formed on an active metal ion conducting membrane in which elongation due to swelling on contact with liquid electrolyte is constrained in at least two of three orthogonal dimensions of the membrane. Within the battery cell structure, the separator is located between the negative and positive electrodes and comprises a layer of said membrane. The membrane material is selected from the group consisting of a fiber-reinforced polymer and a polymer reinforced with a punched, woven or mesh material. Examples of polymers are polyolefins, such as polyethylene and/or polypropylene or preferably a per-fluoro-sulfonic acid polymer assigned as NAFION within US-A 2006/0177732 and also commercially available under this name.

U.S. Pat. No. 6,602,593 discloses a split resistant microporous membrane for use in preparing a battery separator. The respective microporous membrane is made up of at least 80 percent by weight of a polymer selected from the group consisting of polypropylene, polyethylene and a copolymer thereof. Furthermore, the microporous membrane has a specific tear resistance in the transverse direction. It can be a single layer or a co-extruded multi-layer membrane.

Z. Jin et al. (Journal of Power Sources 2008 (2012), pages 163-167) discloses the application of lithiated Nafion ionomer film as functional separator for lithium sulfur cells. The Nafion ionomer film according to Z. Jin et al. is a copolymer of tetra-fluoroethylene and a perfluorovinyl ether, the latter is in accordance with the respective Nafion-definition of US-A 2006/0177732. The lithiated Nafion ionomer film and a liquid electrolyte form together an ionomer electrolyte to be employed in lithium sulfur cells. It is shown within this document that the ionomer electrolyte is electrochemically stable and veritable for lithium and sulfur electrodes.

Q. Tang et al. (accepted manuscript in Journal of Power Sources, online available since Jul. 18, 2013) relates to Nafion coated sulfur-carbon electrodes for high performance lithium-sulfur batteries. Within this document it is disclosed that polymers based on Nafion (in accordance with the above definitions) can also be employed as coating material for electrodes, in particular for cathodes, in order to enhance the cycle stability and improve the Coulombic efficiency of Li—S batteries.

The problem underlying the disclosure herein consists in the provision of novel separators. The object is achieved, in some embodiments, by separators comprising multiple components, such as components a) and b) with

a) a separator backbone; and
b) at least one polymer comprising polymerized units of b1), b2) and optionally b3):
b1) at least one ethylenically unsaturated monomer having no additional functional groups,
b2) at least one ethylenically unsaturated anionic monomer, and
b3) optionally at least one further ethylenically unsaturated monomer having at least one additional functional group.

An advantage of the separators described herein is their beneficial impact on the performance of an electrochemical cell, in particular in a battery. Especially in connection with lithium/sulfur batteries (Li/S batteries), their beneficial performance becomes evident, since the polysulfide shuttle can be drastically reduced or even eliminated. The polysulfide shuttle is characteristic for Li/S batteries in form of the migration of anionic polysulfide species from the cathode to the anode, where the polysulfides undergo irreversible, parasitic reactions.

By employing a separator described herein, the cycle life of electrochemical cells, in particular of Li/S batteries can be prolonged due to the reduction of the polysulfide shuttle on the one hand and by preserving the excellent conductivity of Li-cations on the other hand.

Furthermore, the polymers according to component b) of the disclosure herein show good compatibility with ordinary separator backbones, in particular with polyolefin-based separators. The polarity/charge-density of the polymers can be adjusted by the degree of neutralization. Polymers with a higher molecular weight, for example with a M_{w}-value of at least 50 000 g/mol, in particular in the range of 70 000 to 100 000 g/mol, may provide good thermoplastic properties and can achieve increased mechanical and chemical stability for the separator.

The performance of the separators described herein may be especially beneficial within those embodiments disclosed herein, wherein the polymer according to component b) is contained within the pores of the separator backbone according to component a). Due to electrostatic repulsion between the polymer according to component b) on the one hand and the charged species like polysulfides on the other hand, the pores of the separator backbone are effectively blocked.

In some embodiments, due to the employment of polymers according to component b), the separators described herein can be manufactured cheaper compared to separators made of cost intensive fluoro-sulfonic acid based polymers such as Nafion-type polymers. Furthermore, water can be employed for solvent-based applications of the polymer onto the separator backbone for certain separators described herein, whereas water cannot be employed for those applications with Nafion-type polymers, but chemically more critical solvents like NMP (N-methyl-2-pyrolidone) have to be used instead.

Examples of separators are specified further hereinafter.

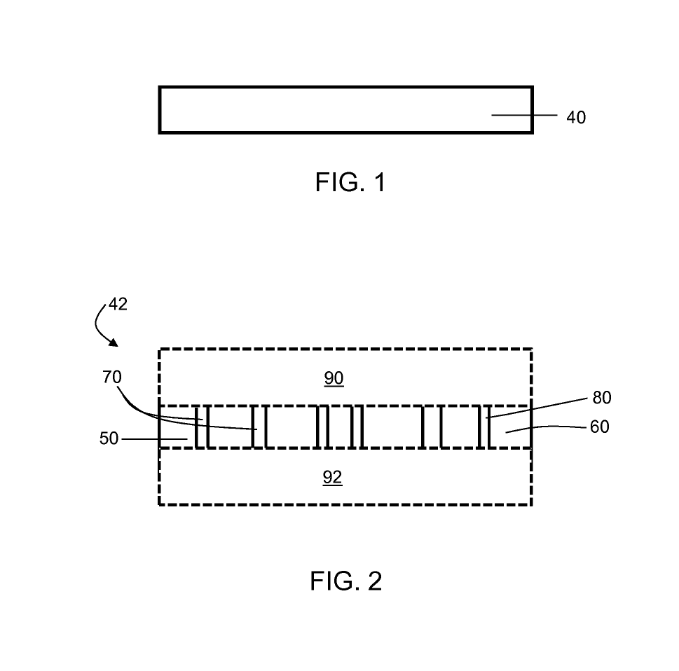

FIG. 1 illustratively shows a separator 40 (a separator material) according to one set of embodiments. As shown illustratively in FIG. 1, the separator may be a single layer of material. However, as described in more detail below, a multi-layered separator is also possible.

It should be appreciated that “separator” and “separator material” are used interchangeably herein.

FIG. 2 illustratively shows a separator 42 including multiple components, including a first layer 50 including a separator backbone 60 having pores 70, and a polymer 80 which may be impregnated in at least a portion of the pores of the separator backbone. In some embodiments, pores 70 are substantially filled with one or more polymers 80. In certain embodiments, the separator backbone may be, for example, component a) as described herein, and/or polymer 80 may be component b) as described herein, although other configurations are possible. While pores 70 shown illustratively in FIG. 2 are substantially straight, in other embodiments, the pores may be tortuous or having other shapes.

As shown illustratively in the embodiment of FIG. 2, the separator may include a single (e.g., first) layer, or may optionally include a second layer (e.g., layer 90), and/or optionally a third layer (e.g., layer 92). For instance, a first layer may be positioned between second and third layers. The second and/or third layers may each independently be the same as, or different from, the first layer. Other configurations are also possible.

As used herein, when a layer (or material) is referred to as being “between” two layers (or materials), the layer (or material) may be directly between the two layers (or materials) such that no intervening layer (or material) is present, or an intervening layer (or material) may be present. Likewise, a layer or material “on”, or “adjacent” another layer (or material), it can be directly on, or adjacent the layer (or material), or an intervening layer (or material) may also be present. A layer (or material) that is “directly on”, “directly adjacent” or “in contact with” another layer (or material) means that no intervening layer (or material) is present.

In other embodiments, a polymer described herein, such as polymer 80, may be attached to a surface of a separator backbone. For example, in addition to or instead of polymer 80 being positioned in the pores of a separator backbone, the polymer may be attached as a layer (e.g., layer 90 and/or layer 92), and/or adjacent to at least one side of the separator backbone. In such embodiments, the pores of the separator may be filled (e.g., partially or fully), or unfilled, with the polymer. In certain embodiments, at least a portion of the polymer (e.g., polymer 80) extends into the pores of the separator (separator backbone). The polymer may extend through or across only a portion, but not all, of the lengths of the pores of the separator (separator backbone), or may extend through or across substantially all of the lengths of the pores of the separator (separator backbone), e.g., from one surface to the opposing surface of the separator (separator backbone). Other configurations are also possible.

Regardless of where polymer 80 is positioned (e.g., in the pores of a separator and/or on a surface of the separator), in some embodiments the polymer comprises an ion conductor, e.g., a lithium-containing group such as a lithium salt, to allow conduction of ions across the polymer.

In certain embodiments, polymer 80 is formed of a different material than the material used to form the separators/separator material.

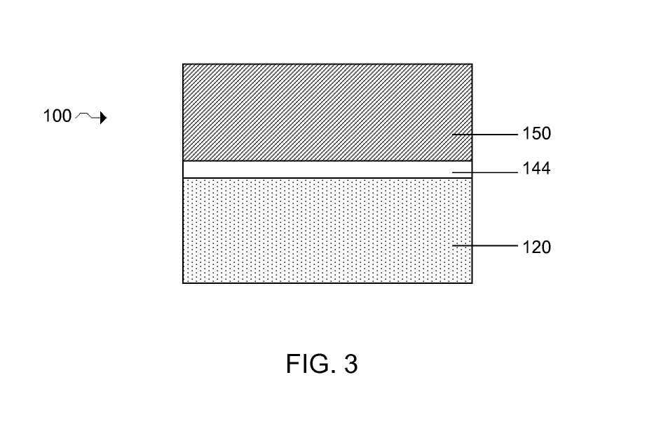

In certain embodiments described herein, a separator can be positioned between an anode 120 and a cathode 150 in an electrochemical cell 100, e.g., as shown illustratively in FIG. 3. For example, a separator 144 may be separator 40 of FIG. 1, separator 42 of FIG. 2, or another separator or polymer matrix described herein. It should be understood that electrochemical cell 100 may include other components not shown in the figure.

As described herein, in some embodiments, a separator described herein comprises multiple components. For example, it may include component a) a separator backbone (e.g., as shown illustratively in FIG. 2). In certain embodiments, any separator known to a person skilled in the art, for example in connection with the use within an electrochemical cell, in particular with the use in a battery, can be employed as a separator backbone. Expressed in other words, the term “separator backbone” means within the context of the disclosure herein the separator material as such, and any material (known to a person skilled in the art) having separator properties can be employed as a separator backbone. Usually, only one (individual) separator is employed as a separator backbone within the present invention. However, it is also possible to employ two, three or even more separators (e.g., layers) as a separator backbone as described herein.

The separator backbone can be, for example, a microporous separator, a nonwoven separator, an ion-exchange membrane, a supported liquid membrane, a polymer electrolyte or a solid ion conductor. An overview on said different types of separators is provided by P. Arora (Chem. Ref. 2004, 104, pages 4419-4462, in particular on pages 4422 and 4423). For example, microporous separators, nonwoven separators and ion-exchange membranes can be made of polyolefins such as polyethylenes (PE) or polypropylene (PP) and mixtures thereof. The separator backbone may be a free-standing polymeric film or layer in some embodiments. In other embodiments, the separator backbone may be supported by another material or layer. The material used to form the separator backbone may be ionically conductive (e.g., lithium-ion conductive), or substantially non-ionically conductive.

The separator backbone may be a layered separator. For example, the separator may be made as a single layer (one-layered) or may contain two, three or even more layers (multi-layer separator). In case of a multi-layer separator, the individual layers may be identical or different. For example, a three-layered separator (a multi-layer separator containing three layers) made of polyolefins can be made of a first polypropylene layer, a second polyethylene layer and a third polypropylene layer. The respective polypropylene of the first layer can be the same or even different (for example in respect of physical parameters due to the preparation process), compared to the polypropylene of the third layer. The dimensions of layered separators, especially in respect of their thickness, are known to a person skilled in the art as disclosed, for example, in the above-mentioned article of P. Arora. A layered separator backbone described herein (e.g., a layered polyolefin separator backbone) may have a thickness of, for example, ≦50 μm, e.g., ≦25 μm.

In some embodiments, a separator backbone is (or comprises) a polyolefin. The term “is a polyolefin” means in the context of the present invention that the respective separator backbone is either completely made of polyolefin or at least 50 wt.-% of the respective separator backbone is made of polyolefin. In other words, the separator backbone is based on a polyolefin. The respective separator backbone may contain, besides polyolefin, further components known to a person skilled in the art and disclosed, for example, in the above-mentioned article of P. Arora, which is incorporated herein by reference in its entirety for all purposes.

In one set of embodiments, the separator backbone is (or comprises) a layered polyolefin and/or a porous polyolefin, and/or the polyolefin is polyethylene (PE), polypropylene (PP) or mixtures thereof. In certain embodiments, the separator is (or comprises) a layered, porous PE or PP.

Specific values and methods for determining the porosity and/or pore sizes of a separator (backbone) are known to a person skilled in the art and they are disclosed, for example, in the above-mentioned article of P. Arora. The term “porous” also includes “microporous” within the context of the present invention. Specific values for “microporous” are disclosed, for example, in U.S. Pat. No. 6,602,593. The pore sizes (e.g., average pore size) of a separator or a separator backbone may be, for example, ≦5 μm, ≦2 μm, ≦1 μm (e.g., ≦1 μm 0.5 microns, between 0.05-5 microns, or between 0.1-0.3 microns).

Polyethylenes (PE) such as low density polyethylene (LDPE), linear low density polyethylene (LLDPE), and high density polyethylene (HDPE) can all be used as the separator backbone. Other materials can also be used. The polyolefins can have a molecular weight of from about 100,000 to about 5,000,000.

Polyolefin separators are commercially available from, for example, Tonen, Celgard and Asahi Kasei as the main manufacturers of such separators. The polyolefin separator 2325 from Celgard (“Celgard 2325”) is a PP/PE/PP microporous trilayer membrane of 25 μm thickness. The inner layer is PE to provide a high-speed shutdown mechanism. As it can be seen by SEM (scanning electron microscope) surface images, Celgard 2325 reveals a highly porous structure with voids interconnected by fibrous material.

As described herein, in some embodiments a separator (e.g., a separator backbone) includes a polymer (e.g., a secondary polymer) associated therewith. For example, the polymer may be on or within at least a portion of the pores of the separator backbone, or a surface of the separator backbone. In some embodiments, the polymer (e.g., polymer 80 shown illustratively in FIG. 2) comprises carboxylate groups. In certain embodiments, the polymer comprises component b) as described herein.

In certain embodiments, component b) of a separator described herein is at least one polymer comprising polymerized units of monomers, at least one of which is an anionic monomer. The resulting polymer may have anionic (e.g., negatively charged) groups. In certain embodiments, the anionic groups are carboxylates, although other anionic groups are possible. As described herein, including anionic groups as part of a separator may have the advantage of repelling certain negatively-charged species present in an electrolyte (e.g., polysulfide species) from reaching the anode.

In certain embodiments, component b) of a separator described herein is at least one polymer comprising polymerized units of b1), b2) and optionally b3:
b1) at least one ethylenically unsaturated monomer having no additional functional groups,
b2) at least one ethylenically unsaturated anionic monomer, and
b3) optionally at least one further ethylenically unsaturated monomer having at least one additional functional group.

The polymer according to component b) as such, as well as the respective methods (processes) for preparing this polymer (by polymerization), can be prepared by any suitable method. Such polymers are disclosed, for example, within the international application PCT/EP 2013/063205, which is incorporated herein by reference. The separator according to the description herein may, in some embodiments, include only one polymer according to component b), but it may include further polymers falling under this definition, for example a mixture of two, three, four or even more of said polymers. In the following, the polymer according to component b) is also assigned as “copolymer”, since it is based on at least two different monomers.

In some embodiments, it is indicated that within the separators described herein the polymer according to component b) as such does not necessarily have any, or may only have rather limited, separator properties. Instead, the separator backbone (separator material) according to component a) may be predominantly responsible for providing the separator properties within, for example, an electrochemical cell. The additional presence of the polymer (e.g., secondary polymer, such as component b)) may provide a significant improvement for the separator properties of the respective separator backbone, especially in connection with elimination or reduction of the unwanted polysulfide shuttle in an electrochemical cell and, in particular, in a Li/S battery. By consequence, the separators according to present invention may alternatively be assigned as “modified separators” due to the combination of components a) and b) within the same separator.

In certain embodiments, monomer b1) comprises at least one ethylenically unsaturated monomer having no (or substantially no) additional functional groups. The term “no additional functional groups” means that the respective monomer is completely or at least predominantly built up by carbon and hydrogen atoms (which means that the respective monomer does not contain any further heteroatoms) and the only functional group or type of functional groups, respectively, is a carbon-carbon double bounding (“ethylenically unsaturated group”) as it is contained in, for example, ethylene. However, a monomer falling under the definition of the monomer b1) may contain two or even more of said carbon-carbon double bondings as they are contained, for example, in butadiene. Examples of additional functional groups, which are not contained with a monomer b1), are explained in detail below in connection with monomer b3).

Non-limiting examples of suitable monomers b1) are selected from ethylene, propylene, 1-butene, 2-butene, iso-butene, 1-pentene, 2-pentene, 1-hexene, 1-octene, polyisobutenes having a number-average molecular weight Mₙ of 100 to 1000 Daltons, cyclopentene, cyclohexene, butadiene, isoprene, and styrene. In some embodiments, the monomer b1) is selected from ethylene, propylene, 1-butene, iso-butene, 1-pentene, 1-hexene, and 1-octene. In certain embodiments, the monomer b1) is ethylene or propylene. In some cases, the monomer b1) is ethylene.

In some embodiments, monomer b2) is at least one ethylenically unsaturated anionic monomer. The term “anionic monomer” means that the respective monomer comprises at least one carboxy group (—COOH/acidic functional group), the respective carboxy group may be either present in form of the free acid or the proton (H) of the respective carboxy group may at least be partially replaced by a cation. The latter case means that the respective anionic monomer is employed partially or even completely in form of a corresponding salt of the respective free acid. Examples of corresponding salts are disclosed below in connection with the at least partially neutralization of a polymer as such. In some embodiments, the monomer b2) is employed in the form of its free acid completely or at least 60%, at least 80%, at least 90%, or at least 95% by weight of the respective monomer is in the form of its free acid. Partial or complete neutralization of the acidic functional groups originating from the monomer b2) may be carried out in the context of the disclosure herein, e.g., after the polymer according to component b) is prepared, and/or prior to attaching the polymer to a separator backbone described herein.

Non-limiting examples of the monomer b2) are selected from acrylic acid, methacrylic acid, itaconic acid, maleic acid or a salt thereof. In certain embodiments, the monomer b2) is acrylic acid or methacrylic acid.

The amount of the monomer b2) to be employed into the polymerization (for example the amount of (meth)acrylic acid, which in this specification stands for methacrylic acid or acrylic acid), in the polymer according to component b), may be, for instance, between 10 and 40 wt.-% (e.g., between 15 and 30 wt.-%), and can be determined by ascertaining the acid number, preferably by potentiometry in accordance with DIN EN ISO 3682.

The optional monomer b3) may be at least one further ethylenically unsaturated monomer having at least one additional functional group. Additional functional groups within the context of the description herein, especially for the monomer b3), are groups of atoms (substituents) which contain at least one atom different to carbon or hydrogen. Examples of additional functional groups of the monomer b3) are selected from hydroxyl, unsubstituted, monosubstituted or disubstituted amino, mercapto, ether, sulfonic acid, phosphoric acid, phosphonic acid, carboxamide, carboxylic ester, sulfonic ester, phosphoric ester, phosphonic ester, or nitrile groups. In some embodiments, the additional functional group is selected from hydroxyl, amino, ether or carboxylic ester groups. In certain embodiments, the additional functional group is selected from ether groups or carboxylic ester groups.

Monomers falling under the definition of monomer b3) according to the description herein are known to persons skilled in the art. It should be understood that each monomer b3) does not fall under the definitions of monomers b1) or b2), respectively. In some embodiments, the monomer b3) is selected from C₁-C₂₀ alkyl(meth)acrylates, vinyl esters of carboxylic acids comprising up to 20 C atoms, ethylenically unsaturated nitriles, or vinyl ethers of alcohols comprising 1 to 10 C atoms.

In certain embodiments, (meth)acrylic acid alkyl esters, including those with a C₁-C₁₀ alkyl radical, e.g., methyl methacrylate, methyl acrylate, n-butyl acrylate, ethyl acrylate, 2-ethylhexyl acrylate, and 2-propylheptyl acrylate, may be used.

Also suitable in particular are mixtures of the (meth)acrylic acid alkyl esters.

In certain embodiments, vinyl esters of carboxylic acids having 1 to 20 C atoms, such as vinyl laurate, vinyl stearate, vinyl propionate, and vinyl acetate, may be used. Examples of nitriles are acrylonitrile and methacrylonitrile.

Suitable vinyl ethers are, for example, vinyl methyl ether, vinyl isobutyl ether, vinyl hexyl ether, and vinyl octyl ether.

Additionally it is possible to use N-vinylformamide, N-vinylpyrrolidone, and N-vinylcaprolactam as monomer b3).

In one set of embodiments, a polymer described herein (e.g., the polymer according to component b)) has a weight-average molar weight M_{w} of at least 45,000 g/mol, at least 50 000 g/mol, at least 55,000 g/mol, at least 60,000 g/mol, at least 65,000 g/mol, or at least 70,000 g/mol (determined by gel permeation chromatography (GPC) with polystyrene as standard and tetrahydrofuran as eluent). The weight-average molar weight M_{w} is generally not more than, for example, 120,000 g/mol, 110,000 g/mol, or 100,000 g/mol. In certain embodiments, the polymer has a M_{w} that is at least 70,000 g/mol and not more than 100,000 g/mol. Other combinations of the above-referenced ranges are also possible.

The weight-average molar weight M_{w} of a polymer described herein (e.g., a polymer according to component b) described herein) may be determined by GPC on the fully methyl-esterified derivative as known to a person skilled in the art. For the full methylation, 10 parts by weight of the acid-functional ethylene copolymer were mixed with 80 parts by weight of methanol and para-toluenesulfonic acid, and the mixture was heated under reflux for 24 hours under atmospheric pressure. The excess methanol is then distilled off, and the derivatized ethylene copolymer is introduced into the GPC measurement.

In some embodiments, a polymer described herein (e.g., a polymer according to component b)) has a melt flow index (MFI) as tested in accordance with ASTM D1238 (version of 2012) at 190° C. under 2.16 kg of 200 to 300 g/10 min, e.g., 240 to 290 g/10 min. In this test a polymeric melt is forced at defined temperature and under a defined (weight) force through an extrusion plastometer. The melt captured after the respective time period is weighed and converted into the amount, in grams, which would have flowed through within 10 minutes.

In another preferred embodiment, a polymer described herein (e.g., a polymer according to component b)) has a melting point of more than 35° C., e.g., more than 40° C., or at least 45° C. (e.g., less than 100° C.).

The amount (in wt.-%) of the monomers to be polymerized to a polymer described herein (e.g., a polymer according to component b)) may be generally as follows:

b1) 40 to 90 wt.-% (e.g., 50 to 85 wt.-%, or 70 to 85 wt.-%),
b2) between 10 and 40 wt.-% (e.g., between 15 and 30 wt.-%),
b3) 0 to 25 wt.-% (e.g., 0 to 15 wt.-%, 0 to 10 wt.-%, 0 to 5 wt.-%, or 0 wt.-%,
with the proviso that the sum total of b1), b2) and b3) always makes 100% by weight.

In some embodiments described herein, a polymer described herein (e.g., a polymer according to component b)) as prepared comprises polymerized units of b1) and b2) with

b1) 70 to 85% by weight of ethylene; and
b2) 15 to 30% by weight of acrylic acid and/or methacrylic acid,
with the proviso that the sum total of b1) and b2) always makes 100% by weight.

The preparation of the polymer according to component b) is known to a person skilled in the art and can be accomplished generally as follows:

The polymers can be prepared in stirred high-pressure autoclaves or in high-pressure tube reactors. The stirred high-pressure autoclaves employed for the preparation process are known per se—a description is found in Ullmann's Encyclopedia of Industrial Chemistry, 5^{th} edition, entry headings: Waxes, vol. A 28, p. 146 ff., Verlag Chemie Weinheim, Basel, Cambridge, N.Y., Tokyo, 1996.

The length:diameter ratio in such autoclaves ranges predominantly from 5:1 to 30:1, e.g., 10:1 to 20:1. The high-pressure stirred reactors that can likewise be employed are likewise found in Ullmann's Encyclopedia of Industrial Chemistry, 5^{th} edition, entry words: Waxes, vol. A 28, p. 146 ff., Verlag Chemie Weinheim, Basel, Cambridge, N.Y., Tokyo, 1996.

Suitable pressure conditions for the polymerization are 500 to 4000 bar, e.g., 1500 to 2500 bar. The reaction temperatures may be in the range from 170 to 300° C., e.g., in the range from 200 to 280° C.

The process can be carried out in the presence of a chain transfer agent. An example of a chain transfer agent used is hydrogen or an aliphatic aldehyde or an aliphatic ketone.

Examples are formaldehyde, acetaldehyde, propionaldehyde, n-butyraldehyde, isobutyraldehyde, n-valeraldehyde, isovaleraldehyde, acetone, ethyl methyl ketone, diethyl ketone, isobutyl methyl ketone, cyclohexanone, cyclopentanone, or cyclododecanone. In some embodiments, propionaldehyde or ethyl methyl ketone as chain transfer agent may be used.

Suitable chain transfer agents may be alkylaromatic compounds, as for example toluene, ethylbenzene, or one or more isomers of xylene.

Other suitable chain transfer agents are unbranched aliphatic hydrocarbons such as propane, for example. Particularly good chain transfer agents are branched aliphatic hydrocarbons with tertiary H atoms, as for example isobutane, isopentane, isooctane, or isododecane (2,2,4,6,6-pentamethylheptane).

The amount of chain transfer agent used corresponds to the amounts which are customary for the high-pressure polymerization process.

As initiators for the radical polymerization it is possible to use the customary radical initiators such as organic peroxides, oxygen, or azo compounds, for example. Mixtures of two or more radical initiators are suitable as well.

Radical initiators used may be one or more peroxides, e.g., selected from the commercially available substances didecanoyl peroxide, 2,5-dimethyl-2,5-di(2-ethylhexanoylperoxy)hexane, tert-amyl peroxy-2-ethylhexanoate, tert-amyl peroxypivalate, dibenzoyl peroxide, tert-butyl peroxy-2-ethylhexanoate, tert-butyl peroxydiethylacetate, tert-butyl peroxydiethylisobutyrate, 1,4-di(tert-butylperoxycarbo)cyclohexane in the form of an isomer mixture, tert-butyl perisononanoate, 1,1-di(tert-butylperoxy)-3,3,5-trimethylcyclohexane, 1,1-di(tert-butylperoxy)cyclohexane, methyl isobutyl ketone peroxide, tert-butyl peroxyisopropyl carbonate, 2,2-di-tert-butylperoxybutane or tert-butyl peroxyacetate; tert-butyl peroxybenzoate, di-tert-amyl peroxide, dicumyl peroxide, the isomeric di(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropyl monohydroperoxide, cumene hydroperoxide or tert-butyl hydroperoxide; or dimeric or trimeric ketone peroxides.

Dimeric or trimeric ketone peroxides and processes for preparing them are known from EP-A 0 813 550, which is incorporated herein by reference.

In some embodiments, particularly suitable peroxides are di-tert-butyl peroxide, tert-butyl peroxypivalate, tert-amyl peroxypivalate, tert-butyl peroxyisononanoate, or dibenzoyl peroxide, or mixtures thereof. An example of an azo compound is azobisisobutyronitrile (“AIBN”). The radical initiators are metered in amounts customary for polymerizations.

The preparation process may be carried out in the presence of solvents, with mineral oils and other solvents which are present in small proportions in the process and have been used, for example, for stabilizing the radical initiator or initiators. Examples of further solvents are aromatic solvents. In some embodiments, aromatic hydrocarbons such as toluene, xylene isomers, and ethylbenzene may be used.

In certain embodiments, aromatic hydrocarbons, (cyclo)aliphatic hydrocarbons, alkanoic acid alkyl esters, alkoxylated alkanoic acid alkyl esters, and/or mixtures thereof may be used.

In some cases, singly or multiply alkylated benzenes and naphthalenes, alkanoic acid alkyl esters, and alkoxylated alkanoic acid alkyl esters, and/or mixtures thereof may be used.

In some embodiments, aromatic hydrocarbon mixtures such as those which comprise predominantly aromatic C₇ to C₁₄ hydrocarbons and which span a boiling range from 110 to 300° C., may be used. In certain embodiments, toluene, o-, m-, or p-xylene, trimethylbenzene isomers, tetramethylbenzene isomers, ethylbenzene, cumene, tetrahydronaphthalene, and/or mixtures comprising them may be used.

Examples thereof are the Solvesso® products from ExxonMobil Chemical, particularly Solvesso® 100 (CAS No. 64742-95-6, predominantly C₉ and C₁₀ aromatics, boiling range about 154-178° C.), 150 (boiling range about 182-207° C.), and 200 (CAS No. 64742-94-5), and also the Shellsol® products from Shell. Hydrocarbon mixtures of paraffins, cycloparaffins, and aromatics are also available commercially under the designations Kristalloel (for example, Kristalloel 30, boiling range about 158-198° C., or Kristalloel 60: CAS No. 64742-82-1), white spirit (for example likewise CAS No. 64742-82-1), or solvent naphtha (light: boiling range about 155-180° C., heavy: boiling range about 225-300° C.). The aromatic content of such hydrocarbon mixtures is generally more than 90 wt %, e.g., more than 95 wt %, more than 98, or more than 99 wt %. It may be useful to use hydrocarbon mixtures with a particularly reduced naphthalene content.

The monomers are typically metered in together or separately. The proportion in the case of metered addition customarily corresponds not precisely to the proportion of the monomer building blocks in the polymer, since certain monomers are incorporated more readily and more quickly into the polymer than as olefins, especially ethylene.

As mentioned above, in some embodiments involving a polymer described herein (e.g., a polymer according to component b)), the acidic functional groups (such as those originating from the monomer b2)) are at least partially neutralized, and in some cases completely neutralized. Partially neutralized may mean a degree of neutralization from, for example, 40 to 90%, e.g., from 50 to 70%. In some cases, neutralization may be a degree of at least 40%, at least 50%, at least 60%, at least 70%, at least 80%, at least 90%, or at least 95% neutralization. In some embodiments, the polymer is completely neutralized (100%).

In other words, neutralization may mean that the acidic hydrogen atoms of the polymer are replaced at least in part by alkali metal ions, alkaline earth metal ions, or protonated cations of amines, e.g., by sodium, potassium, lithium, or ammonium ions (NH₄⁺), e.g., by lithium ions (Li⁺). In some embodiments, the neutralization is carried out by reacting the polymer with a base. The base may be selected from alkali metal oxides, alkali earth metal oxides, hydroxides, hydrogencarbonates, carbonates, or amines. In some cases, the base is LiOH.

In some embodiments, a polymer described herein (e.g., component b)) may have an average ionic conductivity (e.g., lithium ion conductivity) of at least about 10⁻⁷ S/cm, at least about 10⁻⁶ S/cm, at least about 10⁻⁵ S/cm, at least about 10⁻⁴ S/cm, at least about 10⁻³ S/cm, at least about 10⁻² S/cm, at least about 10⁻¹ S/cm, at least about 1 S/cm, or at least about 10 S/cm. The average ionic conductivity may less than or equal to about 20 S/cm, less than or equal to about 10 S/cm, or less than or equal to 1 S/cm. Conductivity may be measured at room temperature (e.g., 25 degrees Celsius).

A polymer described herein (e.g., component b)) can be configured, in some embodiments, to be substantially electronically non-conductive, which can inhibit the degree to which the polymer causes short circuiting of the electrochemical cell. In certain embodiments, all or part of the polymer can be a material having a bulk electronic resistivity of at least about 10⁴, at least about 10⁵, at least about 10¹⁰, at least about 10¹⁵, or at least about 10²⁰ Ohm-meters. The resulting separator may also have a bulk electronic resistivity within one or more of these values.

Those of ordinary skill in the art, given the present disclosure, would be capable of selecting appropriate materials for use as the polymer (e.g., component b)) combined with a separator/separator backbone. Relevant factors that might be considered when making such selections include the charge of the polymer and its ability to repel certain species in the electrolyte; the ability to deposit, or otherwise form the material on or with other materials in the electrochemical cell; the compatibility of the polymer material with other components of an electrochemical cell, such as any components (e.g., anode and/or cathode) directly adjacent the separator; the compatibility of the polymer material with the electrolyte of the electrochemical cell; the ion conductivity of the material (e.g., lithium ion conductivity); and/or the ability to adhere the polymer material to the separator material.

The thickness of a separator described herein may vary. The thickness of the separator may be less than or equal to, e.g., 40 microns, less than or equal to 30 microns, less than or equal to 25 microns, less than or equal to 10 microns, less than or equal to 5 microns, less than or equal to 3 microns, less than or equal to 2 microns, less than or equal to 1 micron, less than or equal to 0.5 microns, less than or equal to 0.1 microns, less than or equal to 0.05 microns. In some embodiments, the separator is at least 0.01 microns thick, at least 0.05 microns thick, at least 0.1 microns thick, at least 0.5 microns thick, at least 1 micron thick, at least 2 microns thick, at least 5 microns thick, at least 10 microns thick, at least 20 microns thick, at least 25 microns thick, at least 30 microns thick, or at least 40 microns thick. Other thicknesses are also possible.

Combinations of the above-noted ranges are also possible.

As described herein, the separator (e.g., separator backbone) may be porous. In some embodiments, the separator (e.g., separator backbone) pore size may be, for example, less than or equal to 5 microns, less than or equal to 1 micron, less than or equal to 500 nm, less than or equal to 300 nm, less than or equal to 100 nm, or less than or equal to 50 nm. In some embodiments, the pore size may be greater than 50 nm, greater than 100 nm, greater than 300 nm, greater than 500 nm, or greater than 1 micron. Other values are also possible. Combinations of the above-noted ranges are also possible (e.g., a pore size of less than 300 nm and greater than 100 nm).

The separator backbone described herein (e.g., component a)) and a polymer described herein (e.g., a polymer according to component b)) can be combined, brought together or attached to one another in any suitable way known to a person skilled in the art. Further details are described below in connection with a process for preparing a separator according to embodiments described herein. In some embodiments, a polymer described herein (e.g., a polymer according to component b)) is attached as a layer to at least one side of the separator backbone (e.g., component a) and/or the polymer (e.g., component b)) is contained within the pores of the separator backbone (e.g., component a)). In certain embodiments, the separator backbone is a layered separator backbone comprising at least one layer and a polymer described herein (e.g., component b)) is attached to only one side of this layered separator backbone. The one side may be the side with the largest area of said layered separator backbone. In case the polymer (e.g., component b)) is attached as a layer to at least one side of a separator backbone (e.g., component a), the layer of polymer (e.g., layer of component b)) may have a thickness of, for example, not more than 10 microns, e.g., not more than 1 micron, and in certain embodiments less than 1 micron.

In one set of embodiments described herein, a separator comprises components a) and b) with

a) a layered polyolefin and/or a porous polyolefin
b) at least one polymer comprising polymerized units of b1), b2) and optionally b3):
b1) at least one monomer selected from ethylene, propylene, 1-butene, iso-butene, 1-pentene, 1-hexene, and 1-octene,
b2) acrylic acid and/or methacrylic acid,
b3) optionally at least one monomer selected from C₁-C₂₀ alkyl(meth)acrylates, vinyl esters of carboxylic acids comprising up to 20 C atoms, ethylenically unsaturated nitriles, or vinyl ethers of alcohols comprising 1 to 10 C atoms.

Within this embodiment, the separator may include i) component a) which is a layered porous PE or PP, ii) monomer b1) which is ethylene and/or propylene, iii) monomer b2) which is a mixture of acrylic acid and methacrylic acid and/or iv) no monomer b3) is used within the component b). Furthermore, in the polymer according to component b) the acidic functional groups originating from the monomer b2) may be at least partially neutralized, e.g., completely neutralized. The neutralization may be carried out by reacting the polymer with a base. The base may be selected from alkali metal oxides, alkali earth metal oxides, hydroxides, hydrogencarbonates, carbonates, or amines. In some cases the base is LiOH. The components a) and b) may be contained within the separator according to embodiments described herein at any suitable ratio. The amount of component b) may be, for example, <10 wt.-%, e.g., <1 wt.-% (in relation to component a)).

In another set of embodiments, a process for preparing a separator as described herein is provided. Within this process for preparing a separator, at least one polymer described herein (e.g., according to component b)) is attached to a separator backbone described herein (e.g., according to component a)). Methods as such for attaching polymers on a separator backbone, which is usually a polymer itself, such as polyethylene or polypropylene, are known to a person skilled in the art.

In some embodiments, a separator is obtained by dissolution of at least one polymer described herein (e.g., component b)) in a solvent. Any suitable solvent known to a person skilled in the art can be used as a solvent in order to perform the dissolution of the respective polymer. The solvent may be selected from, for example, xylene, toluene or chloroform.

Afterwards, the dissolved polymer may be contacted with the separator backbone (e.g., component a)), which can be done by any suitable method known to a person skilled in the art. Due to the contact of the dissolved polymer with the separator backbone, the step of attaching said polymer to a separator backbone is performed.

In certain embodiments, the polymer (e.g., component b)) is attached to the separator backbone according to one of the two options, which are defined as follows. The dissolution of at least one polymer (e.g., component b) in a solvent is
i) followed by doctor-blading the obtained solution of the polymer on the surface of one side of a separator backbone (e.g., component a)) and evaporation of the solvent, or
ii) followed by soaking the obtained solution of the polymer through the separator backbone.

The methods of doctor-blading according to option i) or the soaking of the obtained solution according to option ii) are known to a person skilled in the art and are further defined within the experimental section of the present application.

In one embodiment according to a process described herein, a polymer described herein (e.g., component a)) is at least partially neutralized with at least one base prior to being attached to the separator backbone, although at least partial neutralization with at least one base after being attached to the separator backbone is possible. In some embodiments, the base is employed as a solution, dispersion or mixture in/with water, e.g., the base may be LiOH in water. Specific bases to be employed within this embodiment are defined above in connection with the separator as such. Within this embodiment, complete neutralize (neutralization of 100%) of the polymer (e.g., component a)) with the respective base may be performed.

In certain embodiments, the following are also provided: i) the use of a separator as described above and herein in an electrochemical cell or in a battery, ii) an electrochemical cell comprising such a separator and iii) a battery comprising such a separator. Electrochemical cells and batteries as such are known to a person skilled in the art. In some embodiments, the battery itself is a Li/S battery.

The term “Li/S battery” or “lithium/sulfur battery”, respectively means that the respective battery contains an anode and cathode. The anode itself comprises lithium, whereas the cathode itself comprises sulfur. Specific embodiments of such Li/S batteries are described in more detail below.

As described herein, lithium-sulfur batteries comprising a separator material comprising charged groups are also provided. For example the separator material can comprise negatively charged groups, such as carboxylates. The lithium-sulfur battery may include, for example, an anode, a cathode, and a separator material arranged in between the anode and the cathode, e.g., wherein the separator material comprises carboxylate groups. The separator material can include a polymer as described herein for component b). The separator material may comprise a separator backbone and at least one polymer is formed (or present) on or in the separator backbone.

Electrochemical cells and/or batteries according to embodiments described herein may include, besides the above-described separator according to embodiments described herein, further components such as at least one electrode, at least one electrolyte, at least one solvent and/or at least one conducting salt. Those further components of an electrochemical cell and/or a battery are known to a person skilled in the art.

Usually, an electrochemical cell and/or a battery comprise two electrodes, which electrodes are one anode and one cathode. The respective electrodes comprise at least one electroactive layer which in turn comprises at least one electroactive material. Respective electrodes may further comprise protective structures, preferably as a layer, for example a polymer layer. Such protective structures are known to a person skilled in the art.

A separator described herein may be positioned between the anode on the one hand and the cathode on the other hand of the respective electrochemical cell and/or battery. The separator may be in direct contact with at least one of the electrodes as described herein. However, it is not required to have direct contact between the separator and the respective electrodes since an electrochemical cell and/or battery usually contains at least one electrolyte, which may fill the space between the separator and the electrodes, especially in embodiments in which a layered electrolyte and/or a gel electrolyte are employed.

In some embodiments, the electrochemical cell and/or the battery may include, for example on or within the separator and/or within the electrolyte, one or more ionic electrolyte salts (e.g., dissolved ionic salts), also as known in the art as conducting salts, to increase the ionic conductivity. Examples of ionic electrolyte salts include, but are not limited to, LiTFSI, LiFSI, LiI, LiPF₆, LiAsF₆, LiBOB, derivatives thereof, and other appropriate salts. In some embodiments, a polymer described herein (e.g., component b)) comprises a polymer that includes a lithium-containing group such as a lithium salt.

In some embodiments, the average ionic conductivity (e.g., lithium ion conductivity) of a separator described herein is at least about 10⁻⁷ S/cm, at least about 10⁻⁶ S/cm, at least about 10⁻⁵ S/cm, at least about 10⁻⁴ S/cm, at least about 10⁻³ S/cm, at least about 10⁻² S/cm, at least about 10⁻¹ S/cm, at least about 1 S/cm, or at least about 10 S/cm. The average ionic conductivity may less than or equal to about 20 S/cm, less than or equal to about 10 S/cm, or less than or equal to 1 S/cm. Conductivity may be measured at room temperature (e.g., 25 degrees Celsius).

Suitable electroactive materials for use as cathode active materials in the cathode of the electrochemical cells and/or a battery described herein may include, but are not limited to, electroactive transition metal chalcogenides, electroactive conductive polymers, sulfur, carbon and/or combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a cathode includes one or more of the following materials: manganese dioxide, iodine, silver chromate, silver oxide and vanadium pentoxide, copper oxide, copper oxyphosphate, lead sulfide, copper sulfide, iron sulfide, lead bismuthate, bismuth trioxide, cobalt dioxide, copper chloride, manganese dioxide, and carbon. In another embodiment, the cathode active layer comprises an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. Examples of conductive polymers include polypyrroles, polyanilines, and polyacetylenes.

In some embodiments, electroactive materials for use as cathode active materials in electrochemical cells described herein include electroactive sulfur-containing materials. “Electroactive sulfur-containing materials,” as used herein, relates to cathode active materials which comprise the element sulfur in any form, wherein the electrochemical activity involves the oxidation or reduction of sulfur atoms or moieties. The nature of the electroactive sulfur-containing materials useful in the practice of this invention may vary widely, as known in the art. For example, in one embodiment, the electroactive sulfur-containing material comprises elemental sulfur. In another embodiment, the electroactive sulfur-containing material comprises a mixture of elemental sulfur and a sulfur-containing polymer. Thus, suitable electroactive sulfur-containing materials may include, but are not limited to, elemental sulfur and organic materials comprising sulfur atoms and carbon atoms, which may or may not be polymeric. Suitable organic materials include those further comprising heteroatoms, conductive polymer segments, composites, and conductive polymers.

Suitable electroactive materials for use as anode active materials in the electrochemical cells and/or batteries described herein include, but are not limited to, lithium metal such as lithium foil and lithium deposited onto a conductive substrate, and lithium alloys (e.g., lithium-aluminum alloys and lithium-tin alloys). While these materials may be used, in other embodiments, other cell chemistries are also contemplated. In some embodiments, the anode may comprise one or more binder materials (e.g., polymers, etc.).

The electrochemical cells and/or batteries described herein may further comprise a substrate, as is known in the art. Substrates are useful as a support on which to deposit the anode active material, and may provide additional stability for handling of thin lithium film anodes during cell fabrication. Further, in the case of conductive substrates, a substrate may also function as a current collector useful in efficiently collecting the electrical current generated throughout the anode and in providing an efficient surface for attachment of electrical contacts leading to an external circuit. A wide range of substrates are known in the art of anodes. Suitable substrates include, but are not limited to, those selected from the group consisting of metal foils, polymer films, metallized polymer films, electrically conductive polymer films, polymer films having an electrically conductive coating, electrically conductive polymer films having an electrically conductive metal coating, and polymer films having conductive particles dispersed therein. In one embodiment, the substrate is a metallized polymer film. In other embodiments, described more fully below, the substrate may be selected from non-electrically-conductive materials.

The electrolytes used in electrochemical cells or batteries as described herein can function as a medium for the storage and transport of ions, and in the special case of solid electrolytes and gel electrolytes, these materials may additionally function as a separator between the anode and the cathode. Any liquid, solid, or gel material capable of storing and transporting ions may be used, so long as the material facilitates the transport of ions (e.g., lithium ions) between the anode and the cathode. The electrolyte is electronically non-conductive to prevent short circuiting between the anode and the cathode. In some embodiments, the electrolyte may comprise a non-solid electrolyte.

In some embodiments, an electrolyte layer described herein may have a thickness of at least 1 micron, at least 5 microns, at least 10 microns, at least 15 microns, at least 20 microns, at least 25 microns, at least 30 microns, at least 40 microns, at least 50 microns, at least 70 microns, at least 100 microns, at least 200 microns, at least 500 microns, or at least 1 mm. In some embodiments, the thickness of the electrolyte layer is less than or equal to 1 mm, less than or equal to 500 microns, less than or equal to 200 microns, less than or equal to 100 microns, less than or equal to 70 microns, less than or equal to 50 microns, less than or equal to 40 microns, less than or equal to 30 microns, less than or equal to 20 microns, less than or equal to 10 microns, or less than or equal to 50 microns. Other values are also possible. Combinations of the above-noted ranges are also possible.

The electrolyte can comprise one or more ionic electrolyte salts to provide ionic conductivity and one or more liquid electrolyte solvents. Suitable non-aqueous electrolytes may include organic electrolytes comprising one or more materials selected from the group consisting of liquid electrolytes, gel polymer electrolytes, and solid polymer electrolytes. Examples of useful non-aqueous liquid electrolyte solvents include, but are not limited to, non-aqueous organic solvents, such as, for example, N-methyl acetamides, such as dimethylacetaminde (DMAc) acetonitrile, acetals, ketals, esters, carbonates, sulfones, sulfites, sulfolanes, aliphatic ethers, acyclic ethers, cyclic ethers, glymes, polyethers, phosphate esters, siloxanes, dioxolanes, N-alkylpyrolidones, such as N-methyl pyrolidone (NMP), substituted forms of the foregoing, and blends thereof. Examples of acyclic ethers that may be used include, but are not limited to, diethyl ether, dipropyl ether, dibutyl ether, dimethoxymethane, trimethoxymethane, dimethoxyethane, diethoxyethane, 1,2-dimethoxypropane, and 1,3-dimethoxypropane. Examples of cyclic ethers that may be used include, but are not limited to, tetrahydrofuran, tetrahydropyran (THF), 2-methyltetrahydrofuran, 1,4-dioxane, 1,3-dioxolane (DOL), and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents. Mixtures of the solvents described herein can also be used.

The invention is illustrated hereinafter by the examples. It should be appreciated that the following examples are intended to illustrate certain embodiments of the present invention, but does not exemplify the full scope of the invention.

### EXAMPLES

### Materials and Equipment

All copolymers according to component b) used in this work are obtained as solid granules from BASF. They are obtained by polymerization as known by a person stilled the art and described in detail above. If not state otherwise all other materials are purchased from Aldrich. The separators used for modifications are purchased from Celgard® and Tonen®, respectively. Celgard® 2325 as well as Tonen® Setela are the separator backbones in focus of this experiments. As electrolyte a 1:1 (by weight) mixture of 1,3-dioxolane (DOL) and dimethoxyethane (DME) containing 7.5 wt.-% LiTFSI (Lithium Bis(trifluoromethanesulfonyl)imide) and optionally other additives is been employed.

The polysulfide barrier effect of the separators is tested with an in-house developed device. That device consisted of a U-tube in which the two legs are separated by the respective separators. The two legs are equally filled with electrolyte, solvent mixture and conductive salt as well as various additives if necessary. Only one leg of the U-tube is filled with polysulfides. The diffusion of the charged polysulfide species through the membrane is followed via photometry monitoring the extinction at λ=380 nm.

The ionic conductivity through the separators is determined form pouch cell measurements using Nickel foils as electrodes. As liquid electrolyte the mixture as described above is used. The conductivities are calculated from impedance spectroscopy with the Zahner® Elektrik IM6.

The ethylene/(meth)acrylic acid copolymers according to component b) are characterized as depicted in table 1 below:

TABLE 1
Ethylene/(meth)acrylic acid copolymer (non-neutralized
precursors) used for separator modification.

| Copolymer type | 1 | 2 | 3 |
|---|---|---|---|
| (meth)acrylic | 8 | 19 | 25-29 |
| acid content | | | |
| [%] | | | |
| melt flow index | 1,200-1,600 | 8-12 | 8-12 |
| (160° C./325 g) | [mm/s] at 120° C. | | |
| [g/10 min] | | | |
| acid number | 35-45 | 110-125 | 160-180 |
| [mg KOH/g] | | | |

The term “(meth)acrylic acid” means that a mixture of (approximately two equal parts of) acrylic acid and methacrylic acid (both in form of the free acids) are employed.

### General

The ethylene/(meth)acrylic acid copolymers are—unless indicated otherwise below—neutralized by using LiOH. The respective amount of base is calculated taking into account the acid number of the copolymer to yield full neutralization. The copolymer in its acid form is in the reactor. The reactor is a glass vessel equipped with a stirrer blade, a condenser, thermometer and dropping funnel. Water is added to the system so that the final solid content of the solution is between 10 and 50 wt.-%. The temperature is raised to reflux and the addition of an aqueous 10-% wt. LiOH is started. Upon neutralization the solid material disappeared and eventually a clear solution remained. After completion the solution is cooled to room temperature and filtered through a paper filter to remove solid material. The solution could further be employed for the separator modification.

In case the polymer is used in its free acid form (i.e. non-neutralized) the material is simply dissolved in xylene.

### Solution 1

200 g of an ethylene/methacrylic acid copolymer type 3 (acid number 165 mg KOH/g) is charged into the reactor together with 1002 g deionized water. The mixture is heated to reflux temperature and 145 g of a 10 wt.-% aqueous solution of LiOH is added dropwise. After the complete addition a solution is obtained that subsequently is filtered from residual solid by filtration. The experimental solid content is determined to be 20 wt.-%.

### Solution 2

200 g of an ethylene/methacrylic acid copolymer type 3 with an acid comonomer content of 28 wt.-% is charged into the reactor together with 1002 g deionized water. The Mixture is heated to reflux temperature and 72 g of a 10 wt.-% aqueous solution of LiOH is added dropwise. After the complete addition a solution is obtained that subsequently is filtered from residual solid by filtration. The experimental solid content is determined to be 15 wt. %.

### Solution 3

25 g of an ethylene/methacrylic acid copolymer type 3 with an acid comonomer content of 28 wt.-% dissolved in 500 g xylene. No neutralisation with LiOH is carried out. The dissolution in xylene is done by vigorous stiffing and gentle heating to 50° C. The obtained, filtered solution exhibited a solid content of 5 wt.-%.

### Comparative Example 1

### Unmodified Separator (Pure Separator Backbone)

The ionic conductivity in the pouch cell measurements with the Celgard® 2325 separator and the electrolyte described above produced values in the range 4 mS/cm. The extinction observed in the photometric measurements of the U-tube (380 nm) is 1.2 a.u. after 10 hours, hence the polysulfide concentration equilibrated via migration through the separator.

### Example 1

### Modified Separator 1 (Separator According to the Present Invention Comprising a Separator Backbone and a Polymer According to Component b))

A Celgard® 2325 separator is cut into a round piece in such a way that it fitted perfectly into a Buchner funnel. The Buchner funnel is put onto a vacuum flask and approx. 100 ml of solution 1 are gently deposited on top of the separator. In order to force the liquid to infiltrate the pores of the separator vacuum is applied. Vacuum is applied until all liquid has passed the polymer membrane. Subsequently, remaining liquid on top of the substrate is removed with a Kimwipe and the modified separator dried in a vacuum oven at 80° C. This round piece is used to test for polysulfide diffusion in the apparatus described above. In parallel, another Celgard® separator (10.5×2.5 cm) is prepared in the same manner. This modified separator is in turn used for pouch cell measurements to determine its ionic conductivity which is revealed 0.01 mS/cm. The extinction for the photometric measurements in the U-tube (380 nm) is 0.01 a.u. after an observation time of 40 hours.

### Example 2

### Modified Separator 2

A Celgard® 2325 separator (10.5×2.5 cm) is modified by immersing the substrate into solution 3. After removal the remaining solvent is carefully wiped off and the separator thereafter dried in the vacuum oven at 80° C. Pouch cell measurements are conducted with this substrate and ionic conductivities determined to be 0.3 mS/cm. The extinction for the photometric measurements in the U-tube (380 nm) is less than 0.01 a.u. after an observation time of 40 hours.

### Example 3

### Modified Separator 3

A Celgard® 2325 separator (10.5×2.5 cm) is modified by depositing solution 3 via doctor blading onto the surface. A doctor blade with a 20 μm slit is used. The separator is thereafter dried in the vacuum oven at 80° C. Pouch cell measurements are conducted with this substrate and ionic conductivities determined to be 0.2 mS/cm. The extinction for the photometric measurements in the U-tube (380 nm) is less than 0.01 a.u. after an observation time of 40 hours.

### SUMMARY

It was found that via a straight forward modification of a polyolefin separator with certain ethylene copolymers comprising anionic units efficiently prevents the polysulfide shuttle while preserving good lithium ionic conductivity.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A separator comprising components a) and b) with
a) a separator backbone; and
b) at least one polymer comprising polymerized units of b1) and b2):
b1) at least one ethylenically unsaturated monomer having no additional functional groups,
b2) at least one ethylenically unsaturated anionic monomer.

2. The separator according to claim 1, wherein the at least one polymer comprises b3) at least one further ethylenically unsaturated monomer having at least one additional functional group.

3. The separator according to claim 1, wherein the separator backbone is a polyolefin.

4. The separator according to claim 3, wherein the separator backbone is a layered polyolefin and/or a porous polyolefin.

5. The separator according to claim 4, wherein the polyolefin is polyethylene (PE), polypropylene (PP) or mixtures thereof.

6. The separator according to claim 1, wherein the monomer b1) is selected from ethylene, propylene, 1-butene, 2-butene, iso-butene, 1-pentene, 2-pentene, 1-hexene, 1-octene, polyisobutenes having a number-average molecular weight Mₙ of 100 to 1000 Daltons, cyclopentene, cyclohexene, butadiene, isoprene, and styrene.

7. The separator according to claim 1, wherein the monomer b2) is selected from acrylic acid, methacrylic acid, itaconic acid, maleic acid or a salt thereof.

8. The separator according to claim 2, wherein the additional functional group of the monomer b3) is selected from hydroxyl, unsubstituted, monosubstituted or disubstituted amino, mercapto, ether, sulfonic acid, phosphoric acid, phosphonic acid, carboxamide, carboxylic ester, sulfonic ester, phosphoric ester, phosphonic ester, or nitrile groups.

9. The separator according to claim 2, wherein the monomer b3) is selected from C₁-C₂₀ alkyl(meth)acrylates, vinyl esters of carboxylic acids comprising up to 20 C atoms, ethylenically unsaturated nitriles, or vinyl ethers of alcohols comprising 1 to 10 C atoms.

10. The separator according to claim 1, wherein the polymer according to component b) comprises polymerized units of b1) and b2) with:
b1) 70 to 85% by weight of ethylene; and
b2) 15 to 30% by weight of acrylic acid and/or methacrylic acid,
with the proviso that the sum of b1) and b2) always makes 100% by weight.

11. The separator according to claim 1, wherein, polymer b) comprises at least one polymer comprising polymerized units of b2), wherein b2) comprises acidic functional groups, and wherein the acidic functional groups are at least partially neutralized or completely neutralized.

12. The separator according to claim 11, wherein the neutralized groups are formed by reacting the polymer with a base, wherein the base is selected from alkali metal oxides, alkali earth metal oxides, hydroxides, hydrogencarbonates, carbonates, or amines, or LiOH.

13. The separator according to claim 1, wherein the component b) is attached as a layer to at least one side of the separator backbone of component a) and/or the component b) is contained within the pores of component a).

14. A process for preparing a separator according to claim 1, wherein at least one polymer according to component b) is attached to a separator backbone according to component a), and wherein the separator is obtained by dissolution of at least one polymer according to component b) in a solvent.

15. A process for preparing a separator according to claim 14, wherein the solvent is selected from xylene, toluene or chloroform.

16. A process for preparing a separator according to claim 14, comprising i) doctor-blading the obtained solution of the polymer on the surface of one side of a separator backbone according to component a) and evaporation of the solvent, or ii) soaking the obtained solution of the polymer through the separator backbone.

17. The process for preparing a separator according to claim 14, wherein the polymer according to component a) is at least partially neutralized with at least one base prior to be attached to the separator backbone.

18. The process for preparing a separator according to claim 17, wherein the base is LiOH and is employed as a solution, dispersion or mixture in/with water.

19. An electrochemical cell comprising a separator according to claim 1.

20. The electrochemical cell according to claim 19, wherein the electrochemical cell is a Li/S battery.

21. A lithium-sulfur battery, comprising:
an anode;
a cathode; and
a separator material arranged in between the anode and the cathode, wherein the separator material comprises carboxylate groups.

22. The lithium-sulfur battery according to claim 21, wherein the separator material comprises at least one polymer comprising polymerized units of b1), b2) and optionally b3):
b1) at least one ethylenically unsaturated monomer having no additional functional groups,
b2) at least one ethylenically unsaturated anionic monomer, and
b3) optionally at least one further ethylenically unsaturated monomer having at least one additional functional group,
provided that the polymer comprises at least one carboxylate group.

23. The lithium-sulfur battery according to claim 22, wherein the separator material comprises a separator backbone and the at least one polymer is formed on the separator backbone.
